(19) United States
(12) Patent Application Publication
(10) Pub. No.: US 2009/0087651 A1
(43) Pub. Date: Apr. 2, 2009

(54) Laminating film including a chip

(75) Inventors: Pierre Doublet, Saint Brice (FR); Sandrine Rancien, La Murette (FR)

Correspondence Address: OLIFF & BERRIDGE, PLC, P.O. BOX 320850, ALEXANDRIA, VA, 22320-4850, US

(73) Assignees: ARJOWIGGINS SECURITY, ISSY LES MOULINEAUX (FR); ARJOWIGGINS, ISSY LES MOULINEAUX (FR)

(21) Appl. No.: 12/213,164

(22) Filed: Jun. 16, 2008

Related U.S. Application Data
(63) Continuation of application No. PCT/FR2006/051287, filed on Dec. 6, 2006.

(30) Foreign Application Priority Data
Dec. 15, 2005 (FR) 05 53901

(51) Int. Cl. B32B 3/00

(52) U.S. Cl. 428/337; 428/448; 428/332; 428/473.5; 428/346

(57) ABSTRACT

The present invention relates to a laminating film comprising: a flexible film that is transparent at least in part; a flexible chip fastened to a face of the film; and a thickness-compensating layer, covering the film at least in part around the chip.

In one of its aspects, the present invention relates to a laminating film and to articles including such a film.

The term “article” is used to mean any package, packaging, or protection device, or sheet material, in particular paper. By way of example, the article may constitute a medium for carrying information, in particular a document, such as for example an identity document, a visa, a means of payment, in particular a bank note or a check, a ticket, in particular a ticket for transport or entry to an event, e.g. a sports event or a cultural event, or a coupon, the list not being limiting. For example, the article may also be a foldable case, an assembled box, made of paper or card, or a flexible package made of plastics material. The article may also be a book.

The term “laminating film” is used to designate a film for covering all or part of at least one substrate or structure, e.g. at least one sheet, at least one other film, or a card, or a cover for a book, or a booklet (passport, savings book, or health booklet) or indeed a dust jacket for a book. The laminating film, sometimes also referred to as a plasticizing film, is for example designed to be rolled on together with at least one other layer.

The laminating film may include an adhesive layer and/or may present hot-melt properties.

The film may be applied to the structure or substrate for laminating by being passed between hot or cold rollers, e.g. depending on whether the adhesive is hot-activatable or pressure-sensitive.

The laminating film may be used for protecting data when used with a security document.

Where appropriate, the laminating film may be used for appearance purposes and also for providing mechanical protection, e.g. of a case for packages, or it may be used to provide mechanical and chemical protection for the covers of books or booklets, or dust jackets, in particular.

In hot-lamination methods, the film may be designed to include an adhesive layer from the beginning, and then the film together with its adhesive and the substrate or the structure for laminating are rolled between two hot rollers. Optionally, the film need not include any adhesive and it may adhere to the substrate or to the structure by melting material.

In cold-lamination methods, the film may initially be coated in an adhesive, and then it may be rolled onto the substrate or the structure for laminating, or indeed it may be rolled onto the substrate or the structure with the help of an adhesive that is supplied in liquid form by a coating system, also known as a lamination system, the film and the substrate or the structure being rolled under pressure between two cold rollers.

It is known to incorporate a radiofrequency chip in a document in order to make the document easier to authenticate. International application WO 99/54842 thus describes incorporating a semiconductor polymer chip in a document.

The publication “Circonflex: an ultra-thin and flexible technology for RFID tags”, EMPC 2005, June 12-15, Brugge, Belgium, discloses a method of fabricating a radiofrequency identity (RFID) chip having thickness of about 10 micrometers (μm) for incorporation in papers in particular. Application EP 1 494 169 A1 discloses a flexible chip.

The company PolyIC presents on its Internet site a support inlay for an RFID device that is printed. The inlay is a semi-finished product for sandwiching between a paper or plastics material support and an adhesive layer, for example.

It is also known to use rolling in particular for fastening transparent films onto security documents or papers in order to protect printing, e.g. variable mentions, from wear and from attempts at falsification after printing.

It is also known to provide substrates for packaging with protection from scratching by laminating them with transparent films. Such transparent films may also be partially metal-plated, holographic, printed, pigmented, diffractive, or lenticular, so as to provide a visual effect (advertising tool) or a security effect (preventing counterfeiting).

The present invention seeks in particular to further strengthen security in the use of such films and/or to enable traceability to be provided and/or to offer new functions.

Application WO 03/100721 discloses a method of protecting mentions by means of a transparent film. Such a method is relatively complex to implement and does not lead to a structure that is plane.

The invention provides a laminating film comprising:
a flexible film that is transparent at least in part;
a flexible chip fastened to a face of the film; and
a thickness-compensating layer, covering the film at least in part around the chip.

The term “transparent at least in part” should be understood as meaning that the film can have at least one region that is not opaque and that does not prevent the reading of underlying information on an article that is covered by the laminating film. The transparency may be “visual”, enabling information to be read from under the film, however it may also be “radiofrequency” transparency so as to enable the chip underlying the film to be read.

The term “chip” designates an electronic device of greater or lesser complexity, which may, for example, be an RFID device, and which may include at least one memory and a processor. The chip may optionally enable data to be exchanged without contact, e.g. with the help of at least one integrated antenna, or it may be connected to at least one antenna. Where appropriate, the chip may include an antenna coupled to another antenna on the article and of greater size.

The chip may receive and/or exchange information with at least one auxiliary electronic device optionally carried by the laminating film, such as for example a sensor, in particular a temperature, humidity, pressure, or light sensor, or a sensor that is sensitive to an external condition or to an action, e.g. opening.

The above-mentioned electronic device may also a display device, e.g. a liquid crystal device or a light-emitting device, in particular a light-emitting diode (LED) or an organic light-emitting diode (OLED), or the like.

The chip or the auxiliary electronic device(s) may also be connected to a source of electricity, e.g. formed on the film, e.g. using printing technology.

The thickness-compensating layer may enable a substantially planar structure to be obtained in the presence of the chip and of the auxiliary electronic device(s) and/or of the electricity source.

The film may be electrically insulating, at least in the vicinity of the chip and/or its antenna, if any, in order to avoid impeding operation of the chip.

Nevertheless, the film and/or the thickness-compensating layer and/or the optional adhesive layer may present anti-static properties, e.g. as a result of presenting sufficient electrical conductivity to be capable of evacuating electric charge.

By way of example, the chip may be bonded to the film by adhesive or heat-sealing, or it may be printed thereon. The same may apply to the auxiliary electronic device(s).

The antenna may be a wire antenna, e.g. being fastened by thermocompression in the film. The antenna may also be printed on the film, or transferred thereon, or etched. Because it is flexible, given that it is made at least in part out of a polymer and/or is of small thickness, e.g. using the Circonflex technique described in the above-mentioned EMPC article, the chip is found to be less fragile than conventional thick chips made of silicon, and it is capable of accepting a certain amount of curvature, thereby enabling it to be supported by the film in spite of the film being flexible. Furthermore, the chip is less likely to damage the film.

The chip is preferably made of a material that is capable of being subjected to flexing (in compression) about a radius of curvature of 3 mm, better 2 mm, better still 1 mm, or even 0.75 mm, without suffering damage that prevents it from operating.

The Circonflex chip disclosed in the above-mentioned article is presented as being capable of being subjected to flexing (in compression) about a radius of curvature of 0.7 mm while remaining operational.

Where appropriate, the materials used for making the chip and the film may present refractive indices that are similar, which can make it more difficult to locate the chip visually.

Advantageously, the thickness-compensating layer covers the film, at least all around the chip, and presents thickness that is preferably at least substantially equal to that of the chip.

Thus, the chip need not generate any perceptible extra thickness when the laminating film is fastened on the substrate or structure that is to be laminated.

In addition, the small thickness of the chip combined with the presence of the thickness-compensating layer can make it possible to avoid forming any cavity in the film or the article for the purpose of receiving the chip at least in part, thereby facilitating fabrication.

The use of the laminating film can thus be simplified. The presence of the thickness-compensating layer optionally makes it possible to store the laminating film in a roll.

The invention is particularly suitable for laminating films in which the film is for bonding adhesively onto an identity document such as a passport or for forming a portion of an identity document such as an identity card, the laminating film serving to protect variable mentions, for example. The laminating film may be heat-sealed.

When the laminating film is to be fastened on a document, the thickness-compensating layer is advantageous adhesive, e.g. being adhesive when cold, or in a variant only when hot. When the thickness-compensating layer is adhesive only when hot, it can be easier to pre-position the film on the article that is to be covered.

The thickness-compensating layer could itself be non-adhesive, and be covered in an adhesive layer, which layer may optionally be adhesive only when hot.

By way of example, the laminating film may also be designed to be laminated onto paper or card for producing folding cases, or assembled boxes, or for making flexible packages, the above-mentioned laminating film being rolled onto other films, for example.

The laminating film may be in the form of a roll of film ready for being rolled onto a structure or substrate that is to be laminated, e.g. while hot. Any chips or antennas may be previously fastened to an inside face of the film, e.g. at regular intervals.

The laminating film may also be precut to a format that is adapted to the substrate or the structure that is to be covered.

In another of its aspects, the invention also provides an article including a laminating film as defined above.

When the article is a sheet material, in particular a document, the article may comprise a sheet of paper having the laminating film adhesively bonded thereto.

The article and the laminating film need not include any recesses suitable for receiving the chip, at least in part.

The laminating film may be designed to cover an entire face of a document.

The chip may present a thickness that is less than or equal to 15 μm, better 12.5 μm, e.g. about at least 10 μm, in particular when it is made using the above-mentioned Circonflex method.

In another of its aspects, the invention also provides a laminating film that is transparent at least in part, and that includes a flexible chip.

In another of its aspects, the invention also provides a laminating film comprising:
a flexible film that is transparent at least in part;
a chip made by printing on a face of the transparent film; and
an adhesive layer enabling the film to be fastened on an article.

In another of its aspects, the invention also provides a packaging film having at least one chip fastened thereto.

Such a film may be a heat-shrink film, for example.

In this aspect of the invention, the film does not necessarily include a thickness-compensating layer, even though that is preferable, in particular to make it easier to prepare in the form of a roll, and the film need not be transparent.

The chip may be as defined above or it may be some other chip.

Such a packaging film can increase safety and facilitate traceability.

The chip may be adhesively bonded to the film.

The invention also provides a method of making secure and/or tracking an article, in particular a document, the method including the following step:
fastening on the article a laminating film as defined above.

The invention can be understood on reading the following detailed description of non-limiting embodiments thereof, and on examining the accompanying drawing, in which:

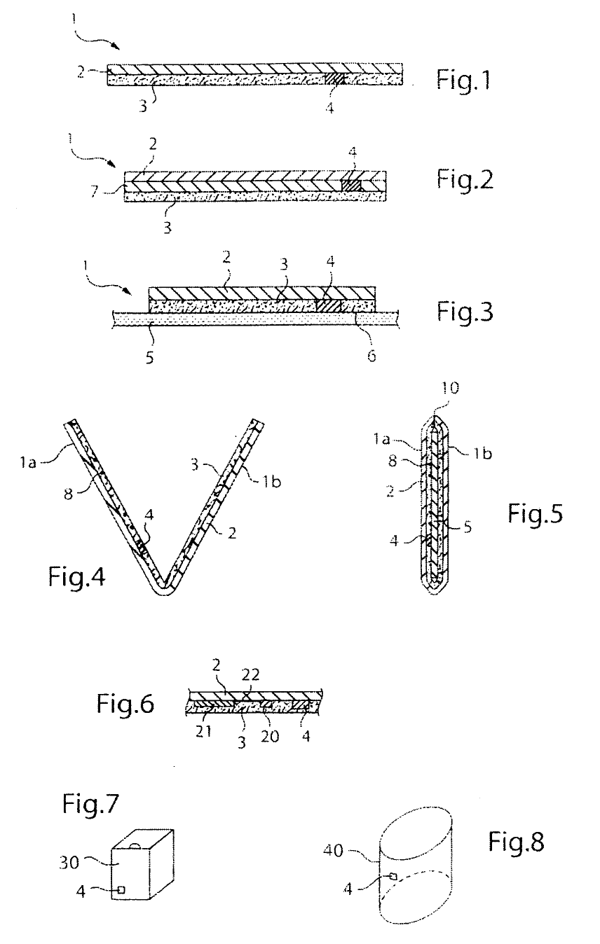

FIG. 1 is a diagrammatic section of a laminating film in accordance with the invention;

FIG. 2 is a view analogous to FIG. 1 showing a variant embodiment;

FIG. 3 shows the FIG. 1 laminating film being fastened on an article;

FIG. 4 is a diagrammatic section showing a variant embodiment of the invention;

FIG. 5 shows the use of the FIG. 4 article for protecting variable mentions;

FIG. 6 shows a variant film;

FIG. 7 shows a box including a film of the invention; and

FIG. 8 shows a packaging film in another aspect of the invention.

In the figures, relative proportions are not complied with, for reasons of clarity in the drawing.

FIG. 1 shows a laminating film 1 comprising a film 2, e.g. of transparent plastics material. On one of its faces, the film 2 carries an adhesive layer 3 and a chip 4, e.g. made of a polymer, in particular a semiconductive and/or an organic polymer, or based on an inorganic material, silicon, and that is sufficiently thin.

In the example of FIG. 1, the adhesive layer 3 serves not only for fastening the security element onto an article 5, as shown in FIG. 3, but also as a thickness-compensating layer, the thickness of the layer 3 being substantially equal to or greater than the thickness of the chip 4.

Thus, the adhesive layer 3 can protect the chip 4 from impacts or pressure exerted during any printing on the film 2, or during treatment of the article 5 covered thereby, for example.

By way of example, the article 5 can be a page of a passport or any other security document, such as a badge or an identity card. The article 5 may also be a folded box, a folding case, etc.

The article 5 may include known security means such as, in particular: printing using optically variable or thermochromic inks; holographic portions in relief; metal plating, at least in part; reactive inks that change color if attacked; inks that are transferable; and inks that are non-transferable in order to reveal attempts at peeling; to mention only a few examples. The film may contain traditional security items so as to enable it to be authenticated or so as to enable it to receive visible printing for personalization purposes.

Chip

The chip 4 serves for example to read and/or write data without making contact, by means of inductive coupling. For this purpose, the chip 4 may include an integrated antenna. In a variant, the chip 4 may be connected electrically to a separate antenna, the antenna being carried by the inside face of the film 2, for example. By way of example, the antenna may be made of wire or may be made by silkscreen printing or by any other printing technique on the film 2.

Naturally, it would not go beyond the ambit of the present invention for the antenna to be made in any other way, for example it need not be electrically connected to the chip 4 but could be inductively coupled thereto, nor would it go beyond the ambit of the present invention for the chip not to include an antenna.

The chip 4 may include conductive, semiconductive, or insulating portions of organic or inorganic material(s), e.g. for forming the functions of a diode, a transistor, a resistor, a capacitor, salt, and/or a data storage function.

In particular, the chip 4 may include an integrated circuit comprising an organic polymer selected for example from conjugated polymers, as described in publication WO 99/54842.

The organic polymer may be selected for example from oligomeric pentacene, poly(thienylene vinylene), or poly-3 alkylthiophene.

The German supplier PolyIC, amongst others, makes semiconductor polymer chips that can be used. By way of example, the chip may be entirely polymeric on a polyester base, with the circuit being made by printing.

By way of example, the chip may be made using thin film transistor circuit (TFTC) technology.

The chip may be printed on the film 2 and it may optionally be encapsulated, in particular so that some of its components are protected from ambient air.

The use of a semiconductor polymer chip can make it possible in particular for the thickness of the chip 4 to be relatively small, e.g. less than or equal to 20 μm.

The chip 4 may comprise a flexible film supporting the circuits of the chip, in particular a polymer film, e.g. a polyimide film. The chip 4 may also be made as taught in application EP 1 494 167.

The chip 4 can thus be made for example using the Circonflex method, in which the circuit is made of a silicon-on-insulator (SOI) wafer and is covered in a polyimide film, after which it is detached from the SOI wafer so as to be supported by the polyimide film.

Whatever the way in which the chip is made, the use of a flexible chip makes it possible, by virtue of the flexibility of the chip 4, to store the security element more easily in a roll prior to use.

If the chip 4 and the film 2 have refractive indexes that are close, then the chip is made more difficult to detect visually, however the chip 4 could be made without presenting a refractive index close to that of the film.

The chip 4 may be fastened or deposited on the film 2 in various ways, in particular by using adhesive, heat-sealing, or printing.

As shown in FIG. 6, the film may include at least one auxiliary electronic device 20, optionally being capable of transmitting or exchanging data with the chip.

This or these auxiliary electronic device(s) 20 can operate independently, e.g. on being exposed to electromagnetic radiation, or can receive energy from a source of electricity 21 that may be carried by the film 2, e.g. a source of electricity that is made using printing technology.

The auxiliary electronic device(s) may be connected to the source electricity 21 by electrical conductors 22.

The auxiliary electronic device(s) may be selected, for example, from sensors, e.g. that are sensitive to pressure, temperature, humidity, light, or conductivity, or that may be sensitive to at least one external condition, e.g. the presence of a gas or a liquid, or a particular compound or an action, e.g. a package being opened or being exposed to light or to oxygen in the air. The sensor may include biosensors.

The auxiliary electronic device(s) may include a capacitive sensor for detecting the presence of a person nearby. The chip may be arranged to cause information to be displayed, e.g. by means of a display device optionally carried by the film, which information may be of a commercial nature, for example. Where appropriate, the display device may be connected to a sensor, optionally via a wired connection.

The auxiliary electronic device(s) may transmit information to the chip 4 that may serve for example to store that information so as to enable it to be read back subsequently by a suitable reader device.

By way of example, this can make it possible to obtain information about the history of the article covered in the film, as a result of some predefined detection, e.g. concerning storage or transport conditions. By way of example, this can be useful for verifying that certain conditions have indeed been complied with prior to the article being made available to consumers.

The auxiliary electronic device(s) may also include at least one display device, e.g. a light-emitting device such as an LED or an OLED, or a liquid crystal device.

Adhesive Layer

Where appropriate, the adhesive layer 3 may contribute at least in part to holding the chip 4 on the film 2.

By way of example, the adhesive layer 3 is constituted by an adhesive that presents adhesion when hot or when cold.

With an adhesive presenting cold adhesion, the adhesive layer 3 may be covered prior to use in a removable protective film, e.g. of silicone paper.

By way of example, the adhesive layer 3 may be an acrylic adhesive.

Film

The film may be made of an optionally-stretchable plastics material, e.g. polyester, polypropylene, or polyurethane, where polyurethane may be preferred in particular when the film is very fine, e.g. of thickness less than or equal to 100 μm, and in particular less than or equal to 50 μm.

The thickness of the film may be even less, for example, less than or equal to 15 μm, or even 12 μm.

The film may be also be made of oriented polypropylene (OPP), of a cellulose acetate, or of a polyamide, such as Nylon®, for example.

On its face 6 covered by the security element 1, the film may include printing, e.g. of variable mentions.

On its surface, the film may include a coating, e.g. a varnish, making it easier to personalize, e.g. by printing.

The film may also be subjected to surface treatment that makes it more suitable for receiving printing.

The print may present antistatic properties.

In numerous applications, it may be advantageous for the film to be transparent, at least visually.

Advantageously, the film may present resistance to scratching by virtue of a special anti-abrasion layer.

When the film is used for laminating on a sheet material, in particular a document, the film may for example be made of extruded polyester terephthalate, e.g. having thickness lying in the range 50 μm to 60 μm.

Particularly for a film that is adapted to be laminated while hot, the film may be made for example of polyethylene terephthalate (PET) covered in a hot-activatable adhesive and carrying the chip. Such a film can be suitable for being hot-rolled onto card during lamination.

When the film is for cold-rolling, e.g. a treated polyethylene (PE) film carrying the chip (treated by the corona effect with or without a bonding primer), the film may be suitable for being rolled onto card during lamination together with a liquid acrylic adhesive.

The film may also be made of PET covered in a pressure-sensitive acrylic adhesive for rolling onto the substrate that is to be covered either by being passed between rollers, or being pressed with the flat of the hand.

Whether lamination is performed hot or cold, a high level of pressure is exerted during rolling and the thickness-compensating layer serves to prevent the chip being damaged by the applied pressure. This thickness compensation may be provided at least in part, and possibly entirely, by an adhesive if it is already present in the structure (as can happen with hot lamination in particular) or by a non-adhesive compensation layer (as can happen with cold lamination).

Such thickness-compensated films provide a final structure that is flat, long-lasting, and of pleasant appearance.

Compensation Layer

The thickness-compensating layer may be the adhesive layer as mentioned above, or at least one non-adhesive layer.

FIG. 2 shows a variant embodiment in which the thickness compensation is provided mainly by an inner layer 7 intermediate between the adhesive layer 3 and the film 2, the inner layer 7 being made for example out of a material that does not have adhesive properties.

Where appropriate, the laminating film may be secured, prior to being fastened on the structure or substrate for laminating, to a support to which the film adheres via its face opposite from the face receiving the chip. Adhesion between the film and the support is sufficiently weak to enable them to be separated without damaging the laminating film. The bonding force between the film and the support is thus less than that between the adhesive layer and the article. By way of example, the support may be a polystyrene film.

The laminating film 1 may form a pocket and include two portions 1a and 1b that are for folding one on the other about the article on which it is desired to protect variable mentions, for example an identity card, and as shown in FIGS. 4 and 5.

In FIG. 4, it can be seen that the chip can be connected to an antenna 8 present on the inside face of one of the flaps of film 2, said antenna being a printed antenna or a wire antenna, for example.

When the security element covers the article 5, the edges 10 of the film can meet around the document 5, as shown in FIG. 5, the film 2 being heat-sealed at its periphery, for example.

The film may also be made with flaps in the manner of a document protector, enabling one of the flaps of the document to be engaged in each of the flaps of the film, the film being capable of folding to accompany the folding of the document in half.

Under such circumstances, the film may optionally be adhesively-bonded to the document.

The invention applies not only to making official documents secure, in particular identity documents, but also to providing traceability and authentication for a variety of articles, such as for example packages or books, to laminating objects . . . .

By way of example, the film of the invention can be useful for making secure and tracing packages, in particular for cosmetics or perfumes or books. Lamination can be performed in particular by hot-rolling with the package or the cover of a book.

By way of example, the works of a library may include protective covers constituted by a laminating film of the invention.

By way of example, the chip in the laminating film can exchange data with a system for automatically recording the lending and return of works.

FIG. 7 shows a cardboard box 30, e.g. formed by folding a sheet having the laminating film stuck to one of its faces, so as to obtain a package that is more attractive, for example.

The presence of the chip 4 on the film may make it possible, for example, to enable a consumer to interrogate it in order to obtain information about the goods contained in the package.

For example it may comprise user instructions or dosages to be complied with if the package contains medicine.

The chip 4 may also be used for the purposes of making a package traceable and/or secure.

By way of example, the film may be arranged in such a manner that opening of the package can be detected by interrogating the chip, such opening acting for example on an auxiliary electronic device that is carried by the film, e.g. an electrical conductor, or being detected by an opening sensor.

In another of its aspects, that can be independent or combined with the above, the invention also provides a packaging film, e.g. in the form of a heat-shrink sheet, as shown in FIG. 8, e.g. prepared in the form of a roll and suitable for incorporating a chip 4, e.g. as defined above or possibly some other chip, in particular a conventional chip based on silicon.

By way of example, the packaging film 40 may optionally be a heat-shrink material.

With a package, the chip may contain information relating to the object contained in the package.

The expression “comprising a” should be understood as being synonymous with “comprising at least one” unless specified to the contrary.

1. A laminating film comprising:
a flexible film that is transparent at least in part;
a flexible chip fastened to a face of the film; and
a thickness-compensating layer, covering the film at least in part around the chip.

2. A laminating film according to claim 1, in which the chip is a polymer chip.

3. A laminating film according to claim 2, the chip comprising a semiconductor and/or organic polymer.

4. A laminating film according to claim 1, in which the chip is inorganic.

5. A laminating film according to claim 4, the chip being based on silicon.

6. A laminating film according to claim 1, in which the chip is a thin chip.

7. A laminating film according to claim 6, in which the thickness of the chip is less than or equal to 20 μm.

8. A laminating film according to claim 7, the thickness of the chip being less than or equal to 15 μm.

9. A laminating film according to claim 1, in which the chip comprises a circuit supported on a polymer film.

10. A laminating film according to claim 9, the polymer film comprising polyimide.

11. A laminating film according to claim 1, in which the thickness-compensating layer covers the flexible film all around the chip.

12. A laminating film according to claim 1, the thickness of the compensating layer being at least substantially equal to the thickness of the chip.

13. A laminating film according to claim 1, the thickness-compensating layer being adhesive when cold.

14. A laminating film according to claim 1, the thickness-compensating film being adhesive when hot.

15. A laminating film according to claim 1, the thickness-compensating layer being non-adhesive and being covered by a cold or hot adhesive layer.

16. A laminating film according to claim 1, the flexible film being made of a stretchable plastics material.

17. A laminating film according to claim 1, the flexible film being visually transparent, at least in part.

18. A laminating film according to claim 1, in which the thickness of the flexible film is less than or equal to 100 μm.

19. A laminating film according to claim 18, the thickness of the flexible film being greater than or equal to 50 μm.

20. A laminating film according to claim 1, including at least one auxiliary electronic device.

21. A laminating film according to claim 20, including a display device and/or a sensor and/or an electricity source.

22. A laminating film according to claim 1, the chip being configured to withstand bending with a radius of curvature of 3 mm without suffering damage preventing it from operating.

23. A laminating film according to claim 1, the chip being configured to withstand bending with a radius of curvature of 2 mm without suffering damage preventing it from operating.

24. A laminating film according to claim 1, the chip being configured to withstand bending with a radius of curvature of 1 mm without suffering damage preventing it from operating.

25. A laminating film according to claim 1, the chip being configured to withstand bending with a radius of curvature of 0.75 mm without suffering damage preventing it from operating.

26. An article including a laminating film as defined in claim 1.

27. An article according to claim 26, the laminating film being bonded to a face presenting printing.

28. An article according to claim 27, the printing including printing of variable mentions.

29. An article according to claim 26, the article and the laminating film not having any recess for receiving the chip at least in part.

30. An article according to of claim 26, in which the laminating film defines at least one outside face of the article in full.

31. An article according to claim 26, in which the laminating film defines the entire outside surface of the article.

32. An article according to claim 26, comprising sheet material having the laminating film fastened thereon.

33. An article according to claim 32, the sheet material being a document such as a booklet or an identity document or a security document, a package, or a book.

34. A method of making secure and/or tracking an article, the method comprising:
adding a laminating film as defined in claim 1 to the article.

35. A method according to claim 34, the article being a document, a book, or a package.

36. A method of making secure and/or tracking an article, the method comprising:
fastening a laminating film as defined in claim 1 on the article by adhesive.

37. A method according to claim 36, the article being a document, a book, or a package.

38. A method of making secure and/or tracking an article, the method comprising:
fastening a laminating film as defined claim 1 on the article by heat-sealing at the periphery of said film.

39. A method according to claim 38, the article being a document, a book, or a package.
